(19) United States
(12) Patent Application Publication
(10) Pub. No.: US 2023/0015723 A1
(43) Pub. Date: Jan. 19, 2023

(54) SYSTEM, METHOD, APPARATUS, AND METHOD FOR DOCUMENT REVIEW, ANALYSIS, AND ANNOTATION

(71) Applicant: Scott Brian Luntz, New Canaan, CT (US)

(72) Inventor: Scott Brian Luntz, New Canaan, CT (US)

(21) Appl. No.: 17/806,010

(22) Filed: Jun. 8, 2022

Related U.S. Application Data
(60) Provisional application No. 63/221,609, filed on Jul. 14, 2021.

(51) Int. Cl. G06F 40/169; G06F 40/205; G06F 9/54

(52) U.S. Cl. CPC G06F 40/169; G06F 40/205; G06F 9/547; G06F 40/295

(57) ABSTRACT

A system, method, apparatus, and computer program product that scans a document to locate potentially significant terms, such as loopholes, legal clauses, as well as other potential harmful language and identifies the significant term to the user for further review. The invention may also provide access resources such as legal resources for the user to utilize. The invention can also produce document scanning software for other professional and technical fields to assess and highlight significant terms. An artificial intelligence (AI) component parses the document and analyze the document to identify one or more significant terms within a corpus of the document, determine a credibility score for the document, and gather and annotate the document with supplemental content related to each of the one or more significant terms.

### CROSS-REFERENCE TO RELATED APPLICATION

This application claims the benefit of priority of U.S. provisional application No. 63/221,609 filed Jul. 14, 2021, the contents of which are herein incorporated by reference.

### BACKGROUND OF THE INVENTION

The present invention relates to electronic documents, and more particularly to document analysis.

A recurring problem is that people agree to legal documents, such as terms and conditions in a software app, a website, a service provider, and the like, without actually looking at the documents. People frequently do not understand legal language in contracts and other documents or do not have the time to read them, which may give the issuing authority rights over the individual or contain unnoticed loopholes or clauses which can be harmful.

Currently there are no systems available for document analysis that allow a user to obtain a review, an analysis, and an annotation of a document.

As can be seen, there is a need for improved systems, apparatus, and methods to provide automated document review, analysis, and annotation.

### SUMMARY OF THE INVENTION

In one aspect of the present invention, a system for analyzing and annotating a document is disclosed. The system includes a server, configured to communicate with one or more computing devices via a communications network. A program product having machine-readable program code for causing, when executed, the server to perform process steps, including receiving a document over the communications via an application program interface (API). An artificial intelligence (AI) component in communication with the server, parses a corpus of the document to identify one or more significant terms within the corpus of the document. The server modifies the document with a supplemental content for each of the one or more significant terms to produce an annotated document. The annotated document containing the supplemental content is then transmitted, via the API and the communications network.

In some embodiments, the process steps include determining, via the AI component, a credibility score for the document based on the one or more significant terms. The credibility score is count of the one or more significant terms identified in the document. The document may be a legal document.

In some embodiments, the process steps include embedding, in the corpus of the document, a callout to identify and locate each of the one or more significant terms within the corpus of the document.

In some embodiments, the process steps include coupling the supplemental content for each of the significant terms in the annotated document with the callout.

In some embodiments, the process steps include determining, by the AI component, a characterization of each of the one or more significant terms within a context of the document and providing the characterization of each of the one or more significant terms in the supplemental content. The characterization of each of the one or more significant terms may include an identification of the one or more significant terms as one or more of: a contract clause, an ambiguity, and an unclear definition.

In some embodiments, the process steps include embedding, with the supplemental content, a recommendation of one or more steps for a resolution of the one or more significant terms.

In some embodiments, the process steps include embedding, with the annotated document, a supplemental content control, that, when operated by a user, links the user with one or more resources relating to each of the one or more significant terms, wherein the one or more resources are determined by the AI component.

In some embodiments, the process steps include embedding a help control within the annotated document, the help control, when activated by a user, the help control is operable to link the user with a resource for conducting a professional review of the document.

These and other features, aspects and advantages of the present invention will become better understood with reference to the following drawings, description and claims.

### BRIEF DESCRIPTION OF THE DRAWINGS

FIG. 1 is a flow chart of illustrating a method for document review, analysis, and annotation.

FIG. 2 is a schematic view of a system implementation for document review, analysis, and annotation.

FIG. 3 is a screen shot of an exemplary analyzed document annotated with supplemental content.

FIG. 4 is a representative system architecture for the for document review, analysis, and annotation system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product for automating document review, analysis, and annotation. In certain embodiments, the invention scans a document to locate potentially significant terms, such as loopholes, legal clauses, as well as other potential harmful language and identifies the significant term to the user for further review. The invention may also provide access resources such as legal resources for the user to utilize. The invention can also produce document scanning for other professional and technical fields to assess and highlight significant terms.

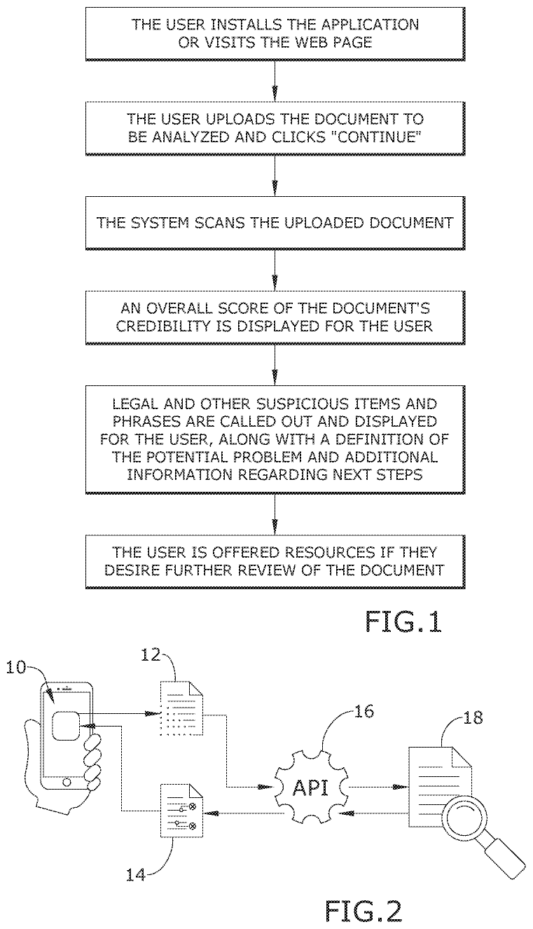

A system and a method according to aspects of the invention are illustrated in reference to FIGS. 1 and 2. The user will install an application 10 to their computing device. Alternatively, the application and system may be hosted on a server, accessible by the Internet from the user's computing device.

When the user has accessed the application 10, the user may then upload a copy of a document to be analyzed by the system. A document communication application program interface (API) 16 is provided for transmission of the document 12 to the server. A document scanner will scan the document for ingestion and use by the system. The document scanner may include an optical character recognition to convert an image document into a text document for use by the system.

Once the document 12 has been ingested by the system, a document analyzer 18, which includes an artificial intelligence (AI) component, will then parse the document 12 and analyze the document 12 to identify one or more significant terms within a corpus of the document 12. The one or more significant terms may include suspicious items or phrases in the corpus of the document 12, such as loopholes, legal clauses, ambiguities, unclear definitions, as well as other potentially harmful language.

Based on the identification of the one or more significant terms, the AI component may determine a credibility score for the document 12. A credibility score 22 may be based a total count of significant terms. The credibility score 22 may alternatively be based on a count of suspicious items. The credibility scored is assigned to the document 12. The credibility score may also be one or more of a trustworthiness, an allocation of risks, a mutuality of obligations, a cost, fees, penalties assessment.

In order to be able to scan documents for legal terms, a natural language processing model capable of performing a Named Entity Recognition (NER) is utilized. By way of non-limiting example a selected advanced processing language, such as SpaCy, may be used to comb through legal documents 12 and scan through a large dataset. SpaCy is used to identify a list of entities to then be analyzed. Once a list of entities is gathered, documents 12 are linked on a semantic basis based on entities listed in each, helping consumers gain an understanding of large multi-part documents.

An autoregressive AI model, such as OpenAI GPT-3 is leveraged to create a short summary of one or more of a section of the document 12, the documents 12 themselves, or the document corpus as a whole. GPT-3 creates these summaries by providing the text content, describing a type of summary desired, and GPT-3 will put out the desired summary. These summaries explain and identify harmful text within the submitted document and are used to annotate identified harmful language, or otherwise suspect language.

For training the AI model, the GPT-3 AI comes pre-trained by a Common Crawl dataset. Through the Common Crawl dataset we are able to locate and submit sample documents 12 which will be utilized for developing the AI model for the present solution. The AI model is trained through the submission of numerous sample documents 12 that contain harmful language, suspect language, as well as documents 12 without.

A supplemented training of the dataset with a large corpus of legal documents is also applied through the OpenAI APIs so the AI model is better suited for legal automation. From identifying which terms could be considered harmful the AI model is able to complete the process of recognizing which terms to point out to the user.

Unlike conventional contract analysis programs, are oriented towards individuals in the legal profession, our solution is focused on legal document analysis and term breakdowns for average individuals with no legal experience. These other AI contract review solutions are typically trained to review legal documents based on a company's pre-defined policies and ensure legal documents follow the company's pre-defined policies.

The autoregressive AI model of the present invention is trained to identify one or more significant terms within the corpus of the document 12 from a layman's (non-legal professional) perspective. To achieve this, the AI model was trained to focus on specifically identifying terms that may not be familiar, particularly their legal significance, to the ordinary layperson without legal training. The AI model was achieved by explaining and providing summaries of terms that the layperson may not recognize. Once trained, the autoregressive AI model then focuses on creating summaries of terms that would not be understood for the layperson with no legal experience.

For our purposes harmful or significant terms are defined as language which could pose a risk to an average consumer's intellectual or physical assets. This could also include language which a non-legal professional may not be able to recognize, therefore posing a risk of being harmful.

The AI is able to identify terms which are harmful versus those which are non-harmful through instructions of which words may indicate harmful language. These terms are scanned using the Named Entity Recognition component to identify the terms marked as relevant. The AI will be focused on the layman through the implementation of a readability machine learning model. Through the implementation of the readability machine learning model, the trained model can judge if a certain document contains information which may be confusing or not recognized as significant by an average non-legal user.

The readability machine learning model may be trained on public domain literature, labeled with either a cross-referenced readability score from data providers, such as Lexile, or may be self-labeled using objective measures such as the Flesch Readability index. The readability machine learning model ingests documents 12 and returns the annotated document 14 containing the flagged, complex text. The document analysis framework will be able to categorize “good” and “bad” documents using one or more sentiment analysis libraries such as SpaCy as well as searching for the complex legal language flagged by the readability model.

Once the one or more significant terms within the corpus of the document 12 are identified, each of the one or more significant terms are highlighted for the user's consideration as an annotated document 14. The highlighting may include coupling of a supplemental content appended to each of the significant terms in the annotated document 14. In this case, the AI component is also configured to determine a meaning of each significant term within the context of the document.

The document communication API 16 is utilized for transmission of the annotated document 14 from the server to the user's computing device.

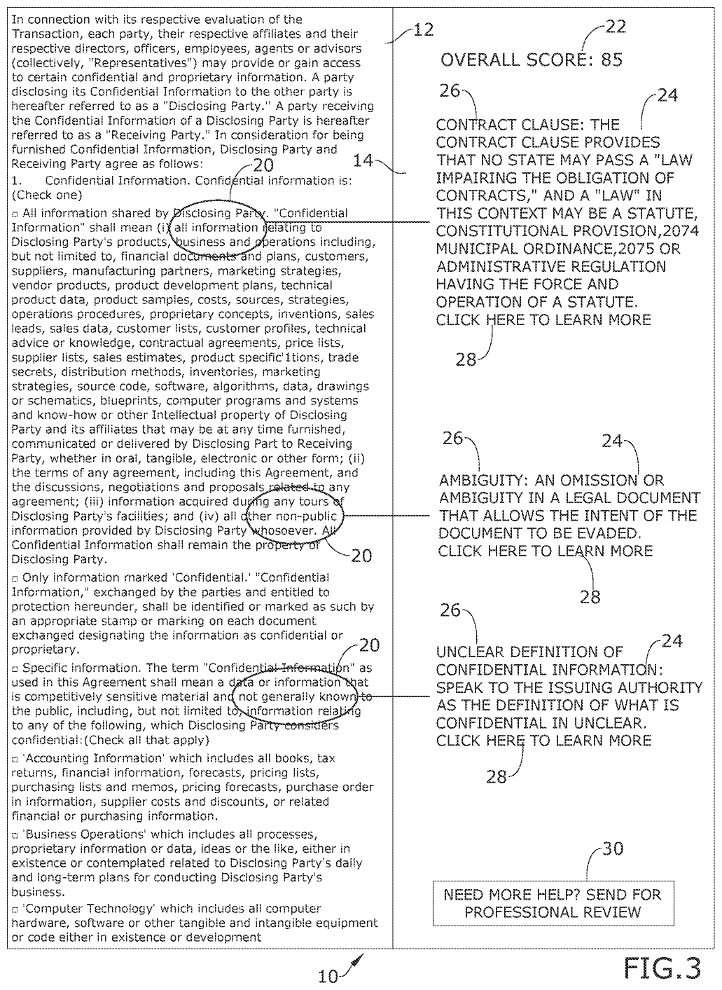

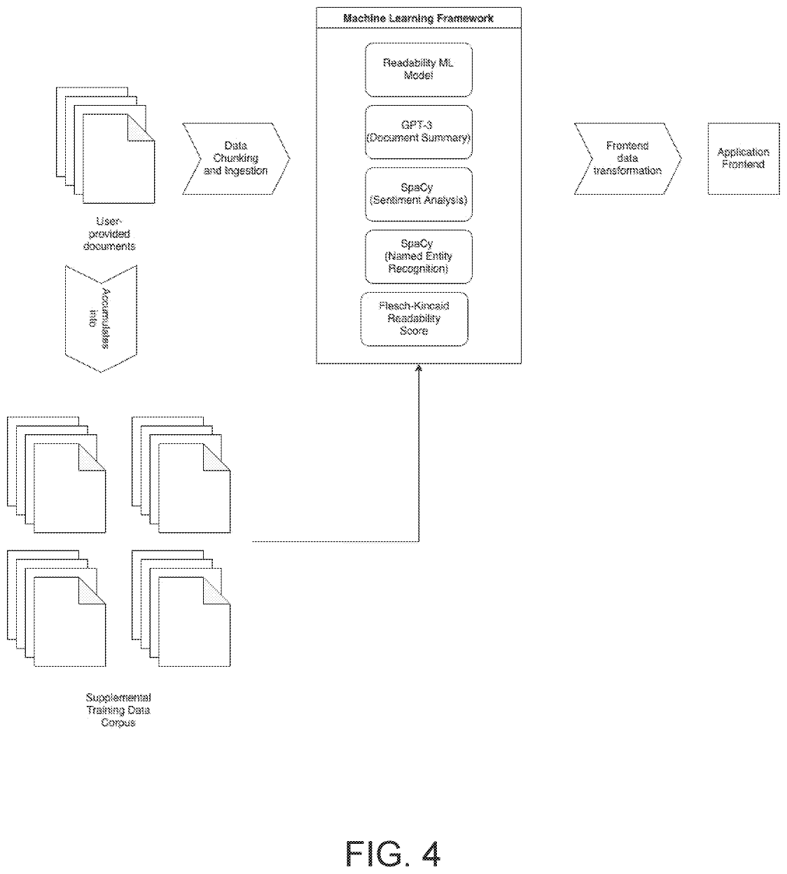

As seen in reference to FIG. 3, the annotated document 14 may include a copy of the document 12 with an annotation for each of the one or more significant terms in the document 12. One or more callouts 20, which may be a graphical symbol, a color change, an underline, or a highlighting is provided in the corpus of the document 12 to identify and locate each of the one or more significant terms within the document 12.

As indicated previously, the annotated document 14 may include a presentation of the credibility score 22. Using a Sentiment Analysis based on the total number of harmful terms identified, the credibility score 22 is created to provide the user with a general idea of the reliability of the submitted document 12.

The annotated document 14 also presents the supplemental content 24 for each of the one or more significant terms. The supplemental content 24 may include a description of a concern with the each of the one or more significant terms within the document 12. The supplemental content 24 may also provide a recommendation on next steps should be taken may be displayed to the user.

In the non-limiting embodiment shown, the supplemental content 24 may include a characterization 26 of the one or more significant terms within the document 12. By way of non-limiting example, the characterization 26, may include identification of the one or more significant terms as a contract clause, an ambiguity, an unclear definition, and the like.

The supplemental content 24 may also include a supplemental content control 28 that, when operated by the user, links the user with one or more resources relating to the significant term. The annotated document 14 may also include a help control 30. When activated by the user, the help control 30 is operable to link the user with a resource for conducting a professional review of the document 12 and assist the user in determining a course of action relative the document 12.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for analyzing and annotating a document, comprising:
a server, configured to communicate with one or more computing devices via a communications network;
a program product comprising machine-readable program code for causing, when executed, the server to perform process steps, comprising:
receiving a document over the communication network, via an application program interface (API),
parsing, via an artificial intelligence (AI) component in communication with the server, a corpus of the document to identify one or more significant terms within the corpus of the document;
modifying the document with a supplemental content for each of the one or more significant terms to produce an annotated document; and
transmitting, via the API over the communications network, the annotated document containing the supplemental content.

2. The system of claim 1, further comprising:
determining, via the AI component, a credibility score for the document based on the one or more significant terms.

3. The system of claim 2, wherein the credibility score is count of the one or more significant terms identified in the document.

4. The system of claim 1, wherein the document is a legal document.

5. The system of claim 4, further comprising:
embedding, in the corpus of the document, a callout to identify and locate each of the one or more significant terms within the corpus of the document.

6. The system of claim 5, further comprising:
coupling the supplemental content for each of the significant terms in the annotated document with the callout.

7. The system of claim 6, further comprising:
determining, by the AI component, a characterization of each of the one or more significant terms within a context of the document; and
providing the characterization of each of the one or more significant terms in the supplemental content.

8. The system of claim 7, wherein the characterization of each of the one or more significant terms includes an identification of the one or more significant terms as one or more of: a contract clause, an ambiguity, and an unclear definition.

9. The system of claim 8, further comprising:
embedding, with the supplemental content, a recommendation of one or more steps for a resolution of the one or more significant terms.

10. The system of claim 1, further comprising:
embedding within the annotated document, a supplemental content control, that, when operated by a user, links the user with one or more resources relating to each of the one or more significant terms, wherein the one or more resources are determined by the AI component.

11. The system of claim 1, further comprising:
embedding a help control within the annotated document, the help control, when activated by a user, the help control is operable to link the user with a resource for conducting a professional review of the document.
